(19) United States
(12) Patent Application Publication
(10) Pub. No.: US 2005/0052272 A1
(43) Pub. Date: Mar. 10, 2005

(54) Inductive component

(75) Inventor: Marc Tiebout, Munchen (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/871,867

(22) Filed: Jun. 18, 2004

Related U.S. Application Data
(63) Continuation of application No. PCT/DE02/04463, filed on Dec. 5, 2002.

(30) Foreign Application Priority Data
Dec. 18, 2001 (DE) 101 62 263.5

(51) Int. Cl. H01F 27/28

(52) U.S. Cl. 336/232

(57) ABSTRACT

Inductive component including precisely one coil having a total inductance and a plurality of spiral turns which are realized in the form of conductor tracks having a conductor track width that tapers toward the center of the plurality of spiral turns, two tapping contacts at the coil, and a control circuit which is connected between the two tapping contacts and alters effective inductance of the coil.

### CROSS-REFERENCE TO RELATED APPLICATION

This application is a continuation of International Patent Application Serial No. PCT/DE02/04463, filed Dec. 5, 2002, which published in German on Jun. 26, 2003 as WO 03/052780, and is incorporated herein by reference in its entirety.

### FIELD OF THE INVENTION

The invention relates to an inductive component.

### BACKGROUND OF THE INVENTION

Modern mobile radio devices, for example mobile telephones, which are generally battery-operated, usually use electronic circuits. These electronic circuits use voltage controlled oscillators and should have a minimum current consumption besides minimum noise owing to the battery operation. In accordance with the prior art, for example in Cranickx J., Steyaert M. S. J.: “A 1.8-GHz Low-Phase-Noise CMOS VCO Using Optimized Hollow Spiral Inductors” in IEEE J. of Solid-State Circuits, Vol. 32, No. 5, pp. 736-744 (1997), Zannoth M., Kolb B., Fenk J., Weigel R.: “A Fully Integrated VCO at 2 GHz” in IEEE J. of Solid-State Circuits, Vol. 33, No. 12, pp. 1987-1991 (1998), and Tiebout M.: “Low-Power Low-Phase-Noise Differentially Tuned Quadrature VCO Design in Standard CMOS” in IEEE J. of Solid-State Circuits, Vol. 36, No. 7, pp. 1018-1024 (2001), use is made of voltage controlled oscillators, also known by the abbreviation VCO, on an LC basis. Such an LC-VCO is a voltage controlled oscillator based on an inductance L and a capacitance C. In the voltage controlled oscillator, an oscillation frequency f is thus produced in accordance with

$$f = \frac{1}{2 π \sqrt{LC}} .$$

A voltage controlled capacitance, a so-called varactor, is traditionally used for setting the oscillation frequency f in the LC-VCO (cf. Andreani P.: “A Comparison between Two 1.8 GHz CMOS VCOs Tuned by Different Varactors” in Proc. of European Solid-State Circuits Conf., pp. 380-383 (1998)). In order to be able to perform larger frequency range adjustments, at the present time either the capacitance C (cf. Kral A., Behbahani F., Abidi A. A.: “RF-CMOS Oscillators with Switched Tuning” in IEEE Proc. of Custom Integrated Circuits Conf., pp. 555-558 (1998)) or the inductance L (cf. Yim S. M., Kenneth K. O.: “Demonstration of a Switched Resonator Concept in a Dual-Band Monolithic CMOS LC-Tuned VCO” in IEEE Proc. of Custom Integrated Circuits Conf., pp. 205-208 (2001)) is switched.

In order to reduce the current consumption and also the phase noise of the voltage controlled oscillator, preferably the ratio L/C should be increased for this purpose in accordance with Tiebout M. Moreover, any series resistance generated by the inductance should additionally be reduced since otherwise an unnecessary power consumption reduces the energy reserves in the battery-operated mobile radio device in an undesirable manner. This would have the disadvantage of considerably reducing the standby time or the operating time of the mobile radio device.

In a conventional voltage controlled oscillator with a switched inductance, a disadvantage that arises is that the power of the voltage controlled oscillator is considerably impaired by the switching element. Switching elements having a low series resistance are usually very large and load the voltage controlled oscillator with fixed additional capacitances that are not inconsiderable. Small switching elements, by contrast, admittedly have only a low additional capacitance, but the small switching elements cause a considerable undesirable series resistance.

In the case of a voltage controlled oscillator with a switched capacitance that can be used as an alternative, a disadvantage that arises, by contrast, is that the ratio L/C is reduced instead of increased for the voltage controlled oscillator. Consequently, the current consumption and the phase noise of the voltage controlled oscillator increase which is undesirable. A further disadvantage is that the switched capacitance gives rise to a considerable additional series resistance with the effect mentioned above.

For a mobile radio device which is intended to be adjustable in a frequency band of ≧30%, thus has dual band capability or multiband capability and can fulfill for example both the GSM standard (GSM=Global System for Mobile communication) with 900 MHz and the DCS 1800 standard (DCS=Digital Communication System) with 1.8 GHz, a voltage controlled oscillator which can be operated with at least two different oscillation frequencies is furthermore required in the integrated circuit. For this purpose, on the substrate on which the integrated circuit is integrated, provision is usually made of a plurality of individual inductances in the form of coils separated spatially from one another, which can be connected in series or disconnected as required. This plurality of coils and their connecting lines have the disadvantage that they cause a considerable space to be taken up on the substrate and, consequently, further minimization of area and reduction of costs for the mobile radio device are obstructed. In addition, the required connecting lines and the plurality of coils, in comparison with a single coil, increase the series resistance with the consequence already described above.

EP 0 720 185 A1 discloses radio frequency low-power CMOS oscillators with electrically tunable open resonant circuits, in which electrically tunable inductances ensure highly efficient oscillator operation, which inductances can be set after production in order to ensure a high yield for high-precision oscillator circuits.

### SUMMARY OF THE INVENTION

The invention is thus based on the problem of specifying an inductive component in which the inductance of the coil used can be varied in a simple manner without additional capacitances being coupled into the integrated circuit of the inductive component in this case, without considerably increasing the series resistance and the space taken up on the substrate.

The problem is solved by means of an inductive component having the features in accordance with the independent patent claim.

An inductive component has precisely one coil having a total inductance, two tapping contacts at the coil, and a control circuit, it being possible to alter the effective inductance of the coil by means of the control circuit.

The coil of the inductive component can thus clearly be regarded as a component having a variably controllable inductance. In this case, however, it is not the total inductance of the coil that is altered, but rather only the effective range of the coil which determines the effective inductance tapped off. The inductive component may be used for example in a VCO or in an amplifier with an inductively controlled load.

Thus, one advantage of the invention is to be seen in the fact that the inductive component requires only a single coil which can be suitably coupled into the circuit of the inductive component in variable fashion. Consequently, the inductive component intrinsically has multiband capability without additional coils having to be connected or disconnected. This has the advantage, moreover, that hardly any additional connecting lines have to be provided in the circuit of the inductive component, as a result of which the series resistance is hardly increased.

In a preferred embodiment of the inductive component, the coil is arranged essentially in one plane. This has the advantage that the coil can be produced using planar technique. Preferably, the inductive component is integrated into an integrated circuit. Consequently, the inductive component and thus also the coil can be produced on a substrate by means of customary fabrication methods of semiconductor technique.

The coil of the inductive component preferably has a plurality of turns and also two end contacts. Preferably, the coil also has an intermediate contact that is electrically coupled to a connection. The coil then clearly represents a differential coil. The connection may be utilized for voltage supply or for current supply purposes, be grounded or remain unutilized. The two end contacts of the coil are usually electrically coupled to an AC voltage connection. Furthermore, the differential coil is preferably a fully differential coil in which the intermediate contact is provided at the center of the coil and thus represents a center contact.

The turns of the differential coil or the fully differential coil are arranged such that they are essentially transposed with one another, thereby forming partial turns. In this case, the turns are arranged essentially in the same plane, which is referred to as turns plane hereinafter. In a concrete consideration, two adjacent turns in each case cross one another at the transposition point as follows: one of the two turns changes within the turns plane from a circulation running at a first distance from the center of the coil to a circulation running at a second distance from the center of the coil. The other of the two turns changes shortly before the transposition point from the turns plane to a transposition plane running parallel, changes there below or above the transposition point from the circulation running at the second distance from the center of the coil to the circulation running at the second distance from the center of the coil and changes shortly after the transposition point from the transposition plane back to the turns plane.

In a preferred development of the inductive component, the two inner partial turns of the fully differential coil are electrically coupled to the two end contacts of the coil. In a concrete consideration, the so-called “hot ends” of the fully differential coil are thus arranged in the coil interior, that is to say at the shortest distance from the center of the fully differential coil.

Preferably, the control circuit of the inductive component has a switch element by means of which it is possible to alter the number of turns between the two tapping contacts of the coil. As a result, it is possible to alter the effective inductance between the two tapping contacts in a stepwise manner. The coil can preferably be shortened by means of the switch element in such a way that at least one outer turn of the coil can be disconnected. If a plurality of switch elements are provided in the control circuit, which switch elements are electrically coupled to the inductive component via more than two tapping contacts it is possible to alter the effective inductance in a multiplicity of steps. Consequently, an inductive component having dual band capability is produced by means of a single switch element, while a plurality of switch elements result in an inductive component having multiband capability.

As an alternative, the control circuit may also have a control element by means of which it is possible to alter the effective inductance between the two tapping contacts of the coil in a continuous manner in a control range. Consequently, the stepwise variability of the effective inductance is also extended by the possibility of fine adjustment of the effective inductance and thus of the inductive component.

In a preferred embodiment of the inductive component, at least one field-effect transistor is provided in the control circuit. The field-effect transistor (FET) employed may be a MIS-FET (Metal Insulator Semiconductor FET) or a MOS-FET (Metal Oxide Semiconductor FET), i.e. an NMOS-FET (n-channel MOS-FET), or a PMOS-FET (p-channel MOS-FET). As an alternative to the field-effect transistor, it is also possible to provide at least one bipolar transistor or an HBT (Heterojunction Bipolar Transistor) in the control circuit.

Preferably, the coil of the inductive component is integrated on a substrate and has a plurality of turns which are realized in the form of conductor tracks having a varying conductor track width. By way of example, the conductor tracks may have a staggered conductor track width which tapers toward the center of the coil.

### BRIEF DESCRIPTION OF THE DRAWINGS

Exemplary embodiments of the invention are illustrated in the figures and are explained in more detail below. In this case, identical reference symbols designate identical components.

FIG. 1 shows a diagrammatic plan view of a fully differential coil in accordance with a first exemplary embodiment of the invention;

FIG. 2 shows an equivalent circuit diagram for the fully differential coil in accordance with the first exemplary embodiment of the invention;

FIG. 3 shows an equivalent circuit diagram for a fully differential coil in accordance with a second exemplary embodiment of the invention;

FIG. 4 shows an equivalent circuit diagram for a fully differential coil in accordance with a third exemplary embodiment of the invention;

FIG. 5 shows an equivalent circuit diagram for a fully differential coil in accordance with a fourth exemplary embodiment of the invention in a VCO;

FIG. 6 shows a diagram of the oscillation frequency in the VCO with the fully differential coil in accordance with the fourth exemplary embodiment of the invention;

FIG. 7 shows a further diagram of the oscillation frequency in the VCO with the fully differential coil in accordance with the fourth exemplary embodiment of the invention;

FIG. 8 shows a diagrammatic plan view of a differential coil in accordance with a fifth exemplary embodiment of the invention; and

FIG. 9 shows an equivalent circuit diagram for the differential coil in accordance with the fifth exemplary embodiment of the invention.

### DETAILED DESCRIPTION OF THE PREFERRED MODE OF THE INVENTION

FIG. 1 shows a diagrammatic plan view of a fully differential coil 100 in accordance with a first exemplary embodiment of the invention.

The fully differential coil 100 in accordance with the first exemplary embodiment of the invention has a spiral arrangement of turns 101 which lie essentially in one plane. In accordance with the first exemplary embodiment, the turns 101 are metallic conductor tracks arranged in a metallization plane on a semiconductor substrate, in order to be able to integrate the fully differential coil 100 into an integrated circuit. Consequently, the metallization plane used for the turns 101 represents the turns plane. Furthermore, the fully differential coil 100 has two end connections 102 and a center connection 103. The total inductance of the fully differential coil 100 can be tapped off between the two end connections 102 while half the total inductance of the fully differential coil 100 can be tapped between one end connection 102 and the center connection 103.

The fully differential coil 100 is arranged symmetrically, so that the turns 101 cross one another regularly. Clearly, the turns 101 are arranged such that they are transposed with one another. The two end connections 102 are electrically coupled to the two innermost partial turns 104. The center connection 103 is electrically coupled to the outermost turn 105.

The two innermost partial turns 104 initially run away from the two end connections 102 and are arranged such that they are transposed with one another at a first transposition point 106, so that the two innermost partial turns 104 become the two second innermost partial turns 107. For this purpose, one of the two innermost partial turns 104 remains in the turns plane and changes there from the innermost ring to the second innermost ring. The other innermost partial turn 104 changes shortly before the transposition point 106 to a second metallization plane arranged parallel to the turns plane. At the transposition point 106, the innermost partial turn 104 then runs in the second metallization plane above or below the innermost partial turn 104 in the turns plane. Shortly after the transposition point 106, the innermost partial turn 104 changes from the second metallization plane back to the turns plane and is routed further there as second innermost partial turn 107. In this case, the turns 101 are arranged in the region of the transposition point 106 in such a way that no electrical contact arises between the turns 101.

Once the innermost partial turns 104 have become the second innermost partial turns 107, the latter run back in the direction of the end connections 102, where they reach a further transposition point 108. At the further transposition point 108, the second innermost partial turns 107 are once again transposed with one another. The transposition of the turns 101 at the further transposition point 108 is effected in the same way as at the transposition point 106. The toing and froing of the turns 101 between the transposition point 106 and the further transposition point 108 is effected through to the outermost turn 105. The latter makes a complete circulation around the previous turns 101 rolled up in spiral fashion. At the level of the further transposition point 108, the outermost turn 105 is electrically coupled to the center connection 103 of the fully differential coil 100.

In accordance with the first exemplary embodiment, the conductor track width of the turns 101, as described in publication Tiebout M., increases more and more from the innermost partial turns 104 up to the outermost turn 105. As a result, it is possible to optimize the ratio L/C and L/R for the fully differential coil 100.

At the level of the further transposition point 108, the two second outermost partial turns 109 are not only electrically coupled to the more inward turns 101, but also have two tapping contacts 110. A control element 111 is electrically coupled to said two tapping contacts 110, said control element being symbolized as a variable resistor.

The control element 111 can be used to alter the number of effective turns 101 of the fully differential coil 100. If the control element 111 short-circuits the two tapping contacts 110, the fully differential coil 100 is shortened by the two second outermost partial turns 109 and also the outermost turn 105. If the control element 111 electrically isolates the two tapping contacts 110 from one another, the fully differential coil 100 acts with its full number of turns. Consequently, by means of the control element 111, the fully differential coil 100 clearly represents a switchable coil. However, the control element 111 can also set any intermediate state between the state “tapping contacts 110 short-circuited” and the state “tapping contacts 110 isolated from one another”. Consequently, it is also possible to set arbitrary intermediate values for the effective inductance, thus resulting in a variable inductance. In the above description, it always holds true that the effective inductance is proportional to the square of the effective number of turns.

In the geometry illustrated, the so-called “hot end” of the fully differential coil 100 is situated in the interior of the fully differential coil 100, that is to say at the two innermost partial turns 104. In the case of differential VCO circuits, the center connection 103 of the fully differential coil 100 can be connected to the ground of the AC voltage in the VCO or be utilized for voltage supply or current supply purposes. Since the radio frequency signal is present between the two end connections 102 and the center connection 103, the voltage swing is distributed geometrically over the fully differential coil 100 from zero at the center connection 103 up to the maximum at the two end connections 102. Additional capacitances in the region of the center connection 103 thus have no influence on the VCO. If an active shortening of the fully differential coil 100 is then performed by means of the two tapping contacts 110 and the control element 111, some turns 101 are blanked out from the center of the fully differential coil 100. The resulting additional capacitances hardly influence the VCO since the active shortening is performed in the region of the center connection 103. Since additional capacitances bring about hardly any disturbance at the center connection 103, it is possible to use a large control element 111 with a low series resistance. Consequently, it is possible to reduce the series resistance of the fully differential coil 100 on the basis of a suitable design of the fully differential coil 100 and the VCO.

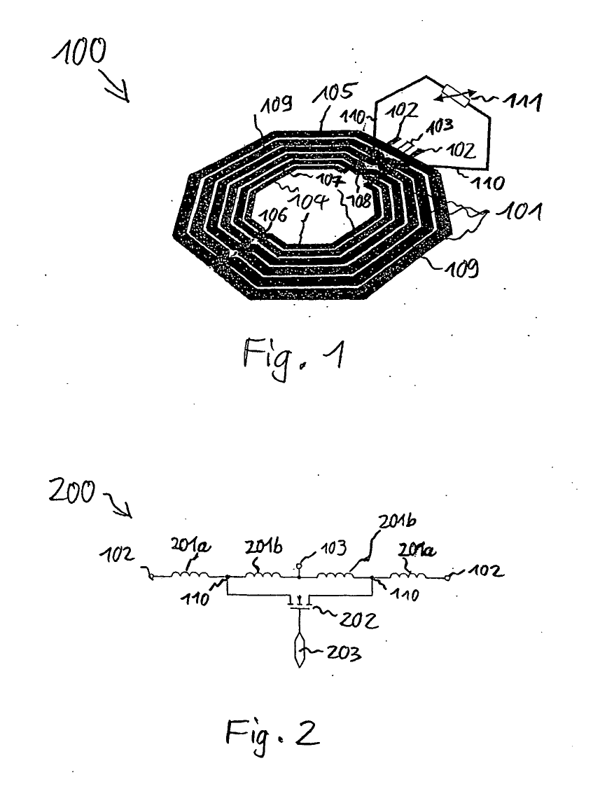

FIG. 2 illustrates an equivalent circuit diagram 200 for the fully differential coil 100 in accordance with FIG. 1.

The fully differential coil 100 is illustrated diagrammatically in the equivalent circuit diagram 200. The turns 101 of the fully differential coil 100 are arranged in the form of four groups 201a, 201b of turns between the two end connections 102. The number of turns 101 in the individual groups 201a, 201b of turns is arbitrary. However, for reasons of symmetry in order to avoid parasitic capacitances and disturbing magnetic fields, the number of turns 101 in the two outer groups 201a of turns is preferably of identical magnitude. Equally, the number of turns 101 in the two inner groups 201b of turns is preferably of identical magnitude.

Furthermore, the equivalent circuit diagram 200 illustrates the center connection 103 and also the two tapping contacts 110 of the fully differential coil 100.

In the first exemplary embodiment of the invention, the control element 111 is realized in the form of an NMOS-FET 202 (n-channel field-effect transistor). In this case, the two tapping contacts 110 of the fully differential coil 100 are electrically connected to the source contact and the drain contact of the NMOS-FET 202.

If a control voltage 203 is applied to the gate contact of the NMOS-FET 202, an electrically conductive charge carrier channel forms in the channel region of the NMOS-FET 202 and the NMOS-FET 202 turns on. Consequently, the two tapping contacts 110 are short-circuited and the two inner groups 201b of turns of the fully differential coil 100 are bridged. The effective inductance of the fully differential coil 100 is then determined exclusively by the two outer groups 201a of turns. The application of the control voltage 203 thus leads to a change in the oscillation frequency in the VCO.

If no control voltage 203 is present at the gate contact of the NMOS-FET 202, the NMOS-FET 202 turns off. Consequently, no electrical connection is produced between the two tapping contacts 110. The inner groups 201b of turns are thus electrically active and the fully differential coil 100 acts with its total inductance.

Furthermore, the effective inductance of the fully differential coil 100 can be varied by virtue of the fact that, given a control voltage 203 present with a suitable magnitude, the NMOS-FET 202 does not turn on completely and, consequently, a current flow is made possible both through the inner groups 201b of turns and through the NMOS-FET 202. In accordance with the current flow through the inner groups 201b of turns, it is possible, then, to vary the effective inductance of the fully differential coil 100 in continuous fashion between the two limit values. Consequently, the NMOS-FET 202 acts not only as a switch but also as a variable control unit.

As an alternative, instead of the NMOS-FET 202, it is also possible to provide a PMOS-FET, which turns off when a control voltage 203 is present, and is electrically conductive when a control voltage 203 is absent.

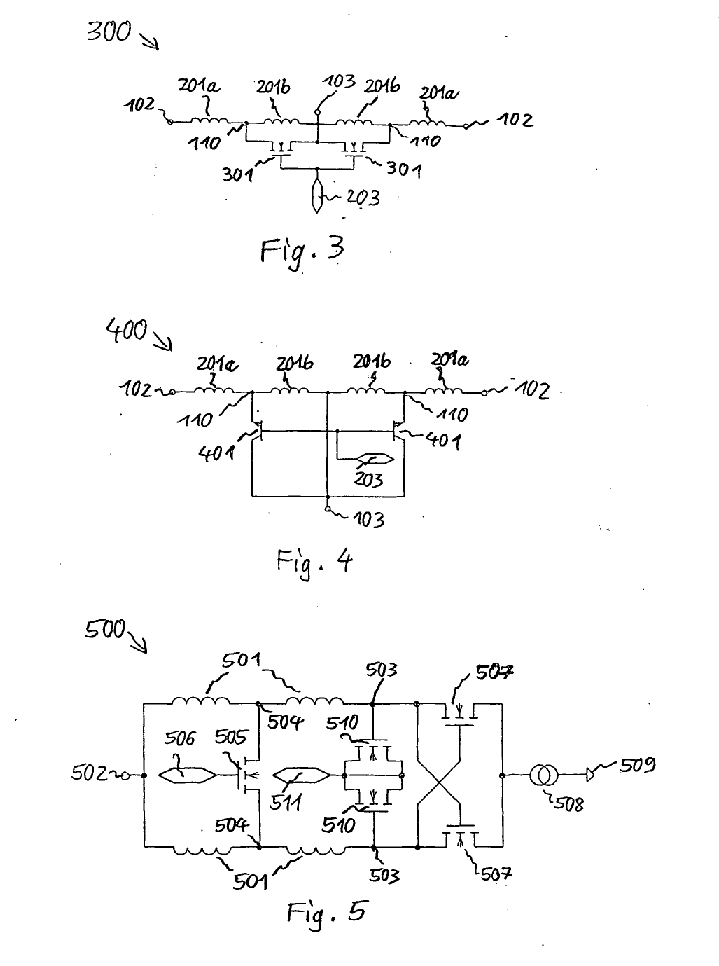

FIG. 3 shows an equivalent circuit diagram 300 for a fully differential coil 100 in accordance with a second exemplary embodiment of the invention.

The equivalent circuit diagram 300 of the second exemplary embodiment differs from the equivalent circuit diagram 200 of the first exemplary embodiment by the fact that two NMOS-FETs 301 are provided in the control circuit for the fully differential coil 100.

The two NMOS-FETs 301 are coupled to the fully differential coil 100 in such a way that when a control voltage 203 is coupled in, which control voltage is then present simultaneously at the respective gate contact of the two NMOS-FETs 301 and makes the two NMOS-FETs 301 electrically conductive, the center connection 103 of the fully differential coil 100 is electrically coupled to the two tapping contacts 110. Consequently, the two inner groups 201b of turns are bridged and the inductance effective at the two end connections 102 of the fully differential coil 100 is formed by the two outer groups 201a of turns.

FIG. 4 illustrates an equivalent circuit diagram 400 for the fully differential coil 100 in accordance with a third exemplary embodiment of the invention.

The equivalent circuit diagram 400 of the third exemplary embodiment differs from the equivalent circuit diagram 200 of the first exemplary embodiment by the fact that two bipolar transistors 401 are provided in the control circuit for the fully differential coil 100.

The two bipolar transistors 401 are coupled to the fully differential coil 100 in such a way that a respective tapping contact 110 is electrically coupled to an emitter contact of one of the two bipolar transistors 401. The collector contacts of the two bipolar transistors 401 are electrically coupled to the center connection of the fully differential coil 100. Depending on the desired state of the bipolar transistors 401, a control voltage 203 can be applied simultaneously to the base contacts of the two bipolar transistors 401.

Despite different components, the control circuit illustrated in the equivalent circuit diagram 400 of the third exemplary embodiment behaves analogously to the control circuit illustrated in the equivalent circuit diagram 300 of the second exemplary embodiment.

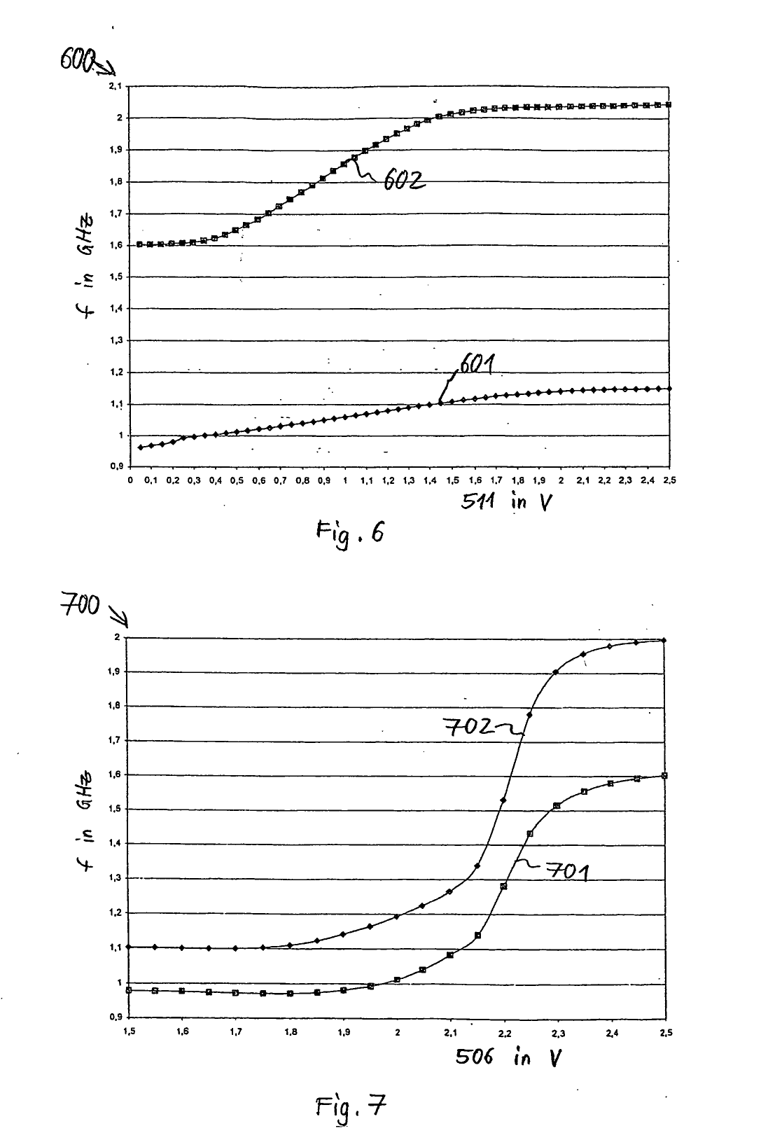

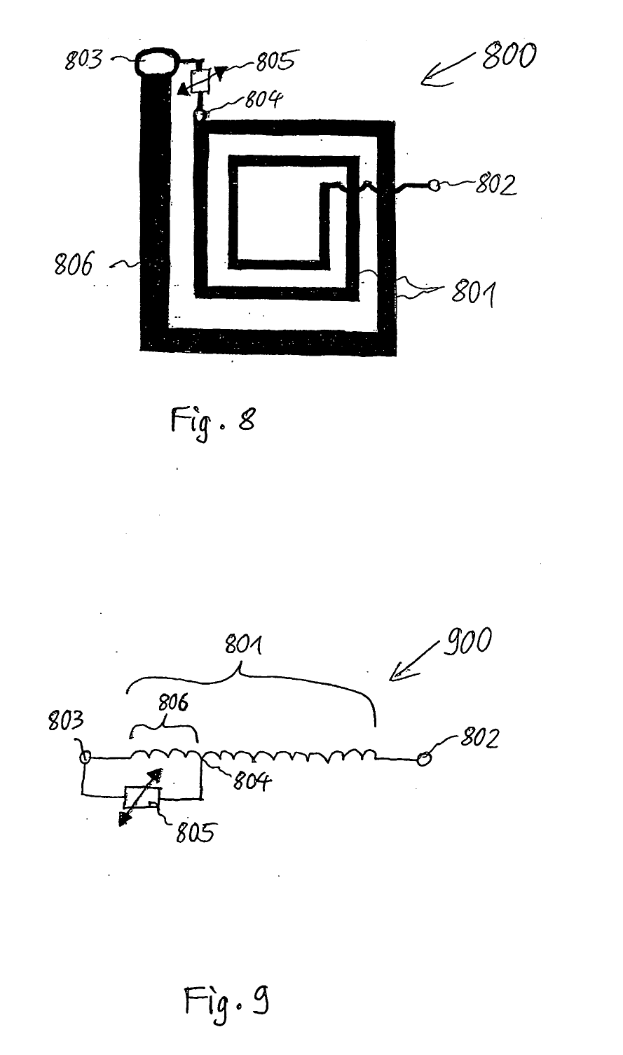

FIG. 5 shows an equivalent circuit diagram 500 for a fully differential coil 100 in accordance with a fourth exemplary embodiment of the invention in a VCO.

The equivalent circuit diagram 500 in accordance with the fourth exemplary embodiment represents a test circuit of a VCO with a fully differential coil 100 which enables an oscillation frequency of between 900 MHz and 1.8 GHz in the VCO.

The fully differential coil 100 is symbolized by four groups 501 of turns. The two end connections of the fully differential coil 100 are combined to form a common end connection 502. In accordance with this exemplary embodiment, a constant voltage of +1.5 V is applied to said common end connection 502. By contrast, the center connection of the fully differential coil 100 is divided into two partial connections 503. The end connection 502 and the partial connections 503 are arranged in such a way that two groups 501 of turns are situated between each partial connection 503 and the end connection 502. Furthermore, a respective tapping contact 504 is also arranged between said respective two groups 501 of turns. The two tapping contacts 504 are coupled to one another by means of an NMOS-FET 505, which can be controlled as desired by means of a control voltage 506, in the same way as in accordance with the exemplary embodiment illustrated in FIG. 2.

The two partial connections 503 are electrically coupled to the ground connection 509 of the circuit via a respective NMOS-FET 507 and a common constant-current component 508. The feedback through the two NMOS-FETs 507 forms a negative resistance, thereby actually enabling oscillation in the VCO. The constant-current component 508 ensures a constant current flow in the VCO despite fluctuating voltages.

The two partial connections 503 are furthermore also electrically coupled to the respective gate contact of two NMOS-FETs 510 acting as capacitors. The capacitance acting on the two partial connections 503 is altered in a manner dependent on the magnitude of the control voltage 511 present at the respective source contact and also at the respective drain contact of the two NMOS-FETs 510. The two NMOS-FETs 510 thus represent a so-called varactor. This variation of the capacitances at the two partial connections 503 also enables control and fine adjustment of the oscillation frequency f present in the VCO.

FIG. 6 illustrates a diagram 600 of the oscillation frequency in the VCO with the fully differential coil 100 in accordance with FIG. 5.

The diagram 600 illustrates the oscillation frequency f of the VCO in accordance with FIG. 5 as a function of the control voltage 511 for capacitance control. The curve 601 reproduces those measured values for the oscillation frequency f which were measured given a control voltage 506 for inductance variation of 0 V, while the curve 602 reproduces those measured values for the oscillation frequency f which were measured given a control voltage 506 for inductance variation of 2.5 V.

The two curves 601 and 602 show that, by changing the control voltage 506 for inductance variation, it is possible to switch the oscillation frequency f back and forth between a first range, lying between 0.95 GHz and 1.15 GHz, and a second range, lying between 1.6 GHz and 2.05 GHz. In this case, the fully differential coil 100 is actively shortened by means of the NMOS-FET 505 acting as the switch. By varying the control voltage 511 for capacitance control, it is possible to perform fine adjustment of the oscillation frequency f in the VCO.

FIG. 7 shows a further diagram 700 of the oscillation frequency in the VCO with the fully differential coil 100 in accordance with FIG. 5.

The further diagram 700 illustrates the oscillation frequency f of the VCO in accordance with FIG. 5 as a function of the control voltage 506 for inductance variation. The curve 701 reproduces those measured values for the oscillation frequency f which were measured given a control voltage 511 for capacitance control of 0 V, while the curve 702 reproduces those measured values for the oscillation frequency f which were measured given a control voltage 511 for capacitance control of 2.5 V.

The two curves 701 and 702 show that, by changing the control voltage 511 for capacitance control, it is possible to variably set the oscillation frequency f within a first range, lying between 0.95 GHz and 1.6 GHz, and within a second range, lying between 1.1 GHz and 2 GHz. In this case, the effective inductance of the fully differential coil 100 is variably altered by means of the NMOS-FETs 510 acting as capacitors. By varying the control voltage 506 for inductance variation, fine adjustment of the oscillation frequency f in the VCO appears to be possible.

FIG. 8 illustrates a diagrammatic plan view of a differential coil 800 in accordance with a fifth exemplary embodiment of the invention.

The differential coil 800 in accordance with the fifth exemplary embodiment has spirally arranged turns 801 which are integrated in the form of conductor tracks on a substrate surface. In accordance with the fifth exemplary embodiment, the spiral arrangement of the turns 801 is effected in square fashion. As an alternative, the spiral arrangement of the turns 801 may for example also be octagonal, round or rectangular. The innermost end of the turns 801 is electrically coupled to a first end connection 802. In this case, the electrical contact between the innermost end of the turns 801 and the first end connection 802 is provided in such a way that this bridges the outer turns 801 in an electrically insulated manner.

The outermost end of the turns 801 is electrically coupled to a second end connection 803. A tapping contact 804 is provided at the second outermost turn, and is electrically coupled to the second end connection 803 via a control element 805. In this case, the control element 805 is symbolized as a variable resistor.

The number of effective turns 801 of the differential coil 800 can be altered by means of the control element 805. If the control element 805 short-circuits the tapping contact 804 with the second end connection 803, the differential coil 800 is shortened by the outermost turn, which thus represents a disconnectable turn 806. If the control element 805 electrically isolates the tapping contact 804 from the second end connection 803, the differential coil 800 acts with its full number of turns. Consequently, by means of the control element 805, the differential coil 800 clearly represents a switchable coil. However, the control element 805 can also set any intermediate state between the state “tapping contact 804 short-circuited with second end connection 803” and the state “tapping contact 804 isolated from second end connection 803”. Consequently, it is also possible to set arbitrary intermediate values for the effective inductance, as a result of which a variable inductance is produced. In the above description, it always holds true that the effective inductance is proportional to the square of the effective number of turns.

FIG. 9 shows an equivalent circuit diagram 900 for the differential coil 800 in accordance with FIG. 8.

1-17. (canceled)

18. An inductive component comprising:
precisely one coil having a total inductance and a plurality of spiral turns which are realized in the form of conductor tracks having a conductor track width that tapers toward the center of the plurality of spiral turns;
two tapping contacts at the coil; and
a control circuit which is connected between the two tapping contacts and alters effective inductance of the coil.

19. The inductive component as claimed in claim 18, wherein the coil is arranged essentially in one plane.

20. The inductive component as claimed in claim 18, wherein the inductive component is integrated into an integrated circuit.

21. The inductive component as claimed in claim 18, wherein the coil has two end contacts.

22. The inductive component as claimed in claim 18, wherein the coil has an intermediate contact, as a result of which the coil represents a differential coil.

23. The inductive component as claimed in claim 22, wherein the intermediate contact is electrically coupled to a ground connection and the two end contacts are electrically coupled to an AC voltage connection.

24. The inductive component as claimed in claim 22, wherein the differential coil is a fully differential coil in which the intermediate contact is provided at the center of the coil and thus represents a center contact.

25. The inductive component as claimed in claim 22, wherein the turns of the differential coil are arranged such that they are essentially transposed with one another, thereby forming partial turns.

26. The inductive component as claimed in claim 25, wherein the two inner partial turns of the fully differential coil are electrically coupled to the two end contacts of the coil.

27. The inductive component as claimed in claim 21, wherein the control circuit has a switch element by means of which it is possible to alter the number of turns between the two tapping contacts of the coil, as a result of which it is possible to alter the effective inductance between the two tapping contacts in a stepwise manner.

28. The inductive component as claimed in claim 27, wherein the coil is shortened by means of the switch element in such a way that at least one outer turn of the coil can be disconnected.

29. The inductive component as claimed in claim 21, wherein the control circuit has a control element by means of which the effective inductance between the two tapping contacts of the coil are altered in a continuous manner in a control range.

30. The inductive component as claimed in claim 18, wherein the control circuit has at least one field-effect transistor.

31. The inductive component as claimed in claim 18, wherein the coil is integrated on a substrate.

32. The inductive component as claimed in claim 18, wherein the conductor tracks have a staggered conductor track width.

33. A voltage controlled oscillator (VCO) having an inductive component as claimed in claim 18.

34. An amplifier with an inductively controlled load having an inductive component as claimed in claim 18.
